(19) United States
(12) Patent Application Publication
(10) Pub. No.: US 2003/0061699 A1
(43) Pub. Date: Apr. 3, 2003

(54) Work pallet for optical fiber

(76) Inventors: Jon H. Appleby, Boston, MA (US); Harold G. Watts JR., Holden, MA (US); Mark Clark, Somerville, MA (US)

Correspondence Address: WOLF GREENFIELD & SACKS, PC, FEDERAL RESERVE PLAZA, 600 ATLANTIC AVENUE, BOSTON, MA, 02210-2211, US

(21) Appl. No.: 09/969,894

(22) Filed: Oct. 2, 2001

(51) Int. Cl. B23Q 7/00

(52) U.S. Cl. 29/559

(57) ABSTRACT

A work pallet for processing optical fiber. The work pallet may be configured to manage lengths of optical fiber for an automated manufacturing process. In this regard, the pallet may be configured to organize and maintain individual fibers in one or more desired positions to facilitate a manufacturing process. For example, the pallet may be employed for an automated fusion splicing process in which pairs of optical fibers are spliced to each other to establish an optical circuit. The pallet presents a platform on which corresponding fibers of an optical fiber module or other device may be arranged in an organized fashion for fiber preparation, fusion splicing, fiber recoating, post-processing storage and the like. The pallet may employ a cross-lacing arrangement in which the fibers extend in opposite directions across the pallet to control fiber slack associated with subsequent fusion splicing or other processing of the fiber pairs. The pallet may include one or more movable retainers for maintaining fiber ends in at least two different positions.

### BACKGROUND OF THE INVENTION

1. Field of the Invention

The present invention relates to a work pallet for transporting and positioning lengths of optical fiber to be used, for example, in forming optical circuit modules.

2. Discussion of Related Art

Optical devices are becoming increasingly popular, particularly for use in networking applications. In an optical network or other optical circuit, optical devices are interconnected via optical fibers, such as optical fiber pigtails, which serve as the transmission media for transmitting information between the devices. Similarly, an optical device is often made up of multiple optical components that are interconnected, internally within the device, via optical fibers.

Conventional techniques for assembling optical circuits are manually intensive because the fiber is not easily manageable. For example, manipulating optical fiber may involve controlling fiber slack, fiber twist and/or the position of the fiber ends. Additionally, the fiber can become damaged due to mishandling, either by hand or by machine.

The assembly of an optical circuit often involves subjecting the ends of one or more optical fibers to various fiber preparation processes, including stripping the protective coating from at least one end portion of a fiber, cleaning the stripped end of the fiber, and cleaving the stripped and cleaned end portion of the fiber to obtain a high quality optical surface. Pairs of prepared fibers may be fusion spliced together to establish an optical circuit. During one or more of these or other processes, the fibers may be handled manually, or placed on some type of transport or holding device.

It is an object of the present invention to provide a work pallet for handling optical fiber.

### SUMMARY OF THE INVENTION

According to one embodiment of the invention, a work pallet is provided for processing optical fiber. The work pallet comprises a base constructed and arranged to support a plurality of optical fibers thereon, and a plurality of retainers movably supported by the base. The plurality of retainers are arranged in a plurality of opposing pairs of retainers disposed along opposite sides of the base, each of the retainers being constructed and arranged to secure an end portion of an optical fiber to the base at a predetermined location. Each of the retainers is movable between a first position to maintain the end portion of the optical fiber in a first position relative to the base and a second position to maintain the end portion of the optical fiber in a second position relative to the base that is different from the first position.

According to another embodiment of the invention, a work pallet is provided for processing optical fiber. The work pallet comprises a base including an optical module region, a fiber processing region and a fiber storage region. The optical module region is constructed and arranged to support an optical component on the base with at least one pair of optical fibers extending from the optical component. The fiber processing region includes at least one pair of first retainers supported by the base, the at least one pair of first retainers being constructed and arranged to secure end portions of the at least one pair of optical fibers in a first orientation. The fiber storage region includes at least one pair of second retainers supported by the base, the at least one pair of second retainers being constructed and arranged to secure the end portions of the at least one pair of optical fibers in a second orientation that is different from the first orientation.

According to a further embodiment of the invention, a work pallet is provided for processing optical fiber. The work pallet comprises a base constructed and arranged to support at least one pair of optical fibers thereon, at least one pair of first retainers movably supported by the base, and at least one pair of second retainers fixedly supported by the base. The at least one pair of first retainers is constructed and arranged to secure the at least one pair of optical fibers in a first predetermined location relative to the base. The at least one pair of second retainers is constructed and arranged to secure the at least one pair of optical fibers in a second predetermined location relative to the base that is different from the first predetermined location.

According to another embodiment of the invention, a work pallet is provided for processing optical fiber. The work pallet comprises a base constructed and arranged to support at least one pair of optical fibers thereon. The pallet also comprises at least one pair of first retainers supported by the base and disposed opposite each other, the at least one pair of first retainers being aligned along a first plane and spaced apart by a first distance. The at least one pair of first retainers is constructed and arranged to secure end portions of the at least one pair of optical fibers along the first plane. The pallet further comprises at least one pair of second retainers supported by the base and disposed opposite each other. The at least one pair of second retainers are aligned with each other along a second plane and spaced apart by a second distance that is less than the first distance, the second plane being parallel to and spaced from the first plane. The at least one pair of second retainers are constructed and arranged to secure the end portions of the at least one pair of optical fibers along the second plane.

According to a further embodiment of the invention, a method is provided for arranging optical fibers on a work pallet for processing the optical fibers. The method comprises: (a) placing first and second optical fibers on a work pallet, the work pallet including a first retainer disposed along a first side of the pallet and a second retainer disposed opposite the first retainer along a second side of the pallet, the first and second retainers being constructed and arranged to secure an end portion of an optical fiber in a predetermined location on the pallet. The method further comprises (b) routing the first optical fiber across the pallet from the first side to the second side; (c) securing the end portion of the first optical fiber to the pallet with the second retainer; (d) routing the second optical fiber across the pallet from the second side to the first side adjacent a length portion of the first optical fiber; and (e) securing the end portion of the second optical fiber to the pallet with the first retainer.

### BRIEF DESCRIPTION OF THE DRAWINGS

In the accompanying drawings, which are herein incorporated by reference, like features that are illustrated in various figures are represented by like reference designations. For purposes of clarity, not every feature may be labeled in every drawing. Various objects and advantages of the present invention will become apparent with reference to the following detailed description, when taken in conjunction with the drawings, in which:

FIG. 1 is a top perspective view of a work pallet for optical fiber according to one illustrative embodiment of the invention;

FIG. 2 is a top plan view of the work pallet of FIG. 1;

FIG. 3 is a bottom plan view of the work pallet of FIG. 1;

FIG. 4 is a side view of the work pallet of FIG. 1;

FIGS. 5a and 5b are cross-sectional views taken along section line 5-5 in FIG. 2 illustrating a process retainer in raised and lowered positions, respectively;

FIG. 6 is an enlarged perspective view of a process retainer of FIGS. 5a and 5b;

FIG. 7 is a bottom plan view of the process retainer of FIG. 6;

FIGS. 8a and 8b are cross-sectional views taken along section line 8-8 in FIG. 6 illustrating a process retainer clamp in closed and open positions, respectively;

FIG. 9 is an enlarged perspective views of a fixed retainer of FIG. 1;

FIG. 10 is an enlarged perspective views of a storage retainer of FIG. 1;

FIG. 11 is the top plan view of the work pallet of FIG. 1 illustrating a pair of optical fibers cross-laced across the fiber processing region of the pallet according to another illustrative embodiment of the invention; and

FIG. 12 is the top perspective view of the work pallet of FIG. 1 schematically illustrating manipulation of a pair of optical fiber relative to the pallet according to another illustrative embodiment of the invention.

### DETAILED DESCRIPTION

The present invention is directed to a work pallet for optical fiber. The work pallet may be configured to manage lengths of optical fiber for an automated or manual manufacturing process. In this regard, the pallet may be configured to organize and maintain individual fibers in one or more desired positions to facilitate the manufacturing process. For example, the pallet may be employed for an automated fusion splicing process in which pairs of optical fibers are spliced to each other to establish an optical circuit. The pallet presents a platform on which corresponding fibers of an optical fiber module or other device may be arranged in an organized fashion for fiber preparation, fusion splicing, fiber recoating, post-processing storage and the like, if desired.

The pallet may be configured to support an optical circuit module, device or other component that requires fiber preparation and/or fiber interconnection. In this regard, the pallet may be configured to support any of a variety of optical modules and the like on which it may be desirable to perform one or more manufacturing processes. The optical module may be secured to or simply placed on a desired region of the pallet.

Optical fibers extending from the module may be arranged on the pallet in one or more pairs of corresponding fibers that may eventually be interconnected to form at least a portion of an optical circuit. The end portions of each pair of fibers may be arranged to extend away from each other along opposite sides of the pallet for fiber processing. A cross-lacing arrangement, in which the fibers extend in opposite directions across the pallet, may be employed to control fiber slack associated with subsequent fusion splicing or other processing of the fiber pairs.

The end portion of each fiber may be secured to the pallet using a movable retainer that is configured to maintain the fiber end in at least two different positions. For example, the retainer may be configured to selectively maintain the fiber end in an extended position and a non-extended position. In the extended position, the fiber end may be presented to receive one or more manufacturing processes, such as fiber preparation processes. In the non-extended position, the fiber end may be retracted partially or completely within the confines of the pallet.

Upon completion of the desired fabrication processes, the fibers may be repositioned in another location of the pallet. For example, when a pair of fibers is spliced together, the end portions, which had extended outwardly from the pallet in opposite directions, are interconnected to form a fiber loop that extends from the optical module. One or more retainers may be provided to receive and secure each fiber loop in another region, such as a storage region, of the pallet. The storage retainers, which may be stationary or fixed relative to the pallet, may be spaced from the movable process retainers in a longitudinal direction away from the optical module to manage the fiber slack associated with the fabrication processes. In this manner, fibers that had been laced across the width of the pallet may be reoriented along the length and within the confines of the pallet to protect the fiber from potential damage.

The work pallet may arranged with a plurality of pairs of movable process retainers and a corresponding plurality of pairs of storage retainers for accommodating optical modules having any of a number of optical fibers requiring preparation, splicing, recoating and other processes. Each pair of retainers may be aligned in a plane across the width of the pallet with the planes associated with each pair of retainers being spaced apart in a direction along the length of the pallet. The planes for each pair of retainers may be equally or unequally spaced from each other, as desired, for any particular application. Additionally, some pairs of retainers may be spaced apart a particular distance to accommodate a desired orientation of the optical fibers, while other pairs of retainers may be spaced apart a different distance to accommodate a different orientation of the optical fibers.

The work pallet may be used in an automated fabrication system that employs active manipulation of the optical fiber from the pallet for one or more processes. For example, fiber preparation of the end portions of the fiber may occur with the fibers maintained in a desired position on the pallet. The fibers may then be lifted from the pallet to undergo fusion splicing, recoating and the like processes. Upon completion of such processes, the fiber may be returned to the pallet for storage and/or subsequent processes.

The work pallet may also accommodate pairs of optical fibers on the work pallet in an organized manner that minimizes or eliminates axial movement of the optical fiber and affords easy access to the ends of the optical fiber in the event that it is desirable to process the fiber ends. The retainers may be configured to hold fibers having any one of a range of fiber diameters to allow the pallet to be used with optical modules having fibers of different fiber diameters. The retainers may be operable between a locked position for securing a fiber to the pallet and an unlocked position for releasing the fiber from the pallet. The retainers may be actuated automatically by components of the fabrication system or manually by an operator.

The work pallet may include one or more features that cooperate with any suitable transport arrangement to allow the pallet to be automatically conveyed along an automated fabrication system. The work pallet may also include one or more features to prevent the fiber from exceeding its minimum bend radius to avoid potential damage or a degradation in the operability of the optical fiber.

While the pallet may be particularly suited for and is described in conjunction with automated fusion splicing of optical fiber, it should be appreciated that the work pallet is in no way restricted in this manner. Rather, the work pallet may be employed in any desirable application for any number of various fiber processes. Additionally, it is to be appreciated that the pallet may be employed with any type of fiber, wire, cable or cable-like device that may benefit from managing multiple fibers and the like for one or more fabrication processes.

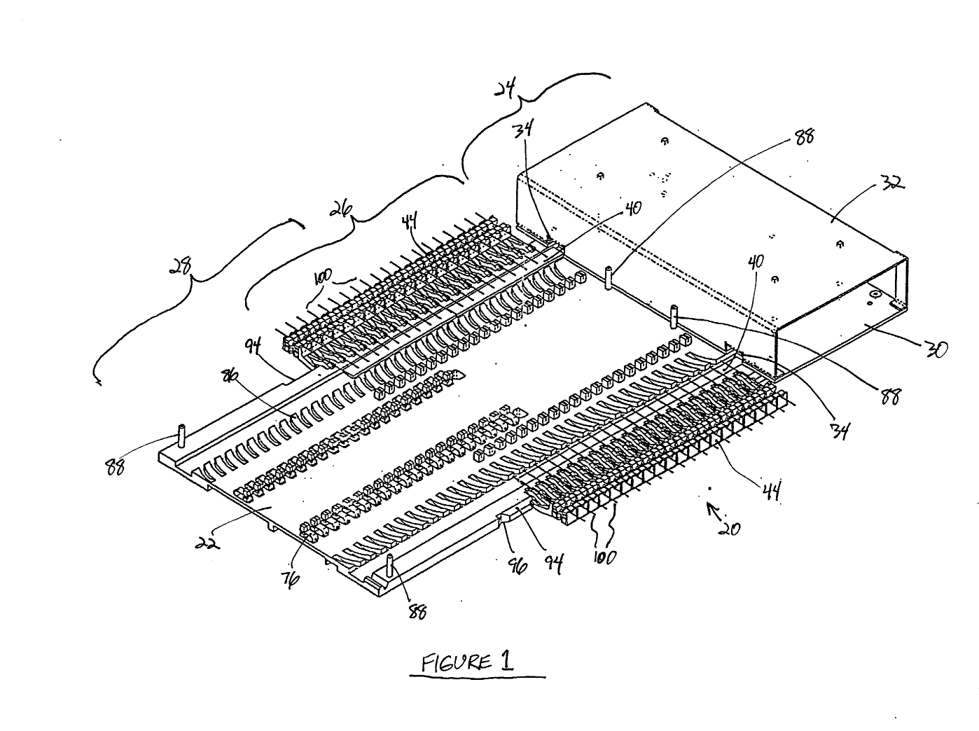

In one illustrative embodiment shown in FIGS. 1-4, the work pallet 20 includes a base 22 for supporting an optical circuit module or like device having one or more lengths of optical fiber extending therefrom. The base 22 is configured to organize the optical fiber in a manner that allows it to undergo one or more manufacturing processes. The base is also configured to retain and organize the fiber upon completion of the processes.

In one embodiment, the base 22 includes a module support region 24 at one end that is configured to support any type of optical module having optical fiber that is to be processed for fusion splicing to form one or more optical circuits within the module. The optical fiber is organized in a fiber processing region 26 of the base which is configured to present the fiber to one or more fiber process tools or stations. Once processed, the fiber is placed on a fiber storage region 28 that is configured to maintain the fiber in an organized and protected arrangement for subsequent assembly into the module. It should be appreciated that the pallet is not limited to the particular configuration described herein as any number of regions and may be implemented with the pallet to carry out any desirable processes.

The module support region 24 includes a support plate 30 configured to support an optical circuit module adjacent the fiber processing region. A cover 32 may be attached to the support plate 30 to constrain the optical fiber within the module support region and prevent undesirable interaction of the optical fiber with, for example, optical fiber processing tools or machines. The cover 30 may be provided with a pair of apertures 34 adjacent opposite sides of the fiber processing region 26 that are adapted to route corresponding pairs of optical fiber from the module support region 24 along opposing sides of the pallet.

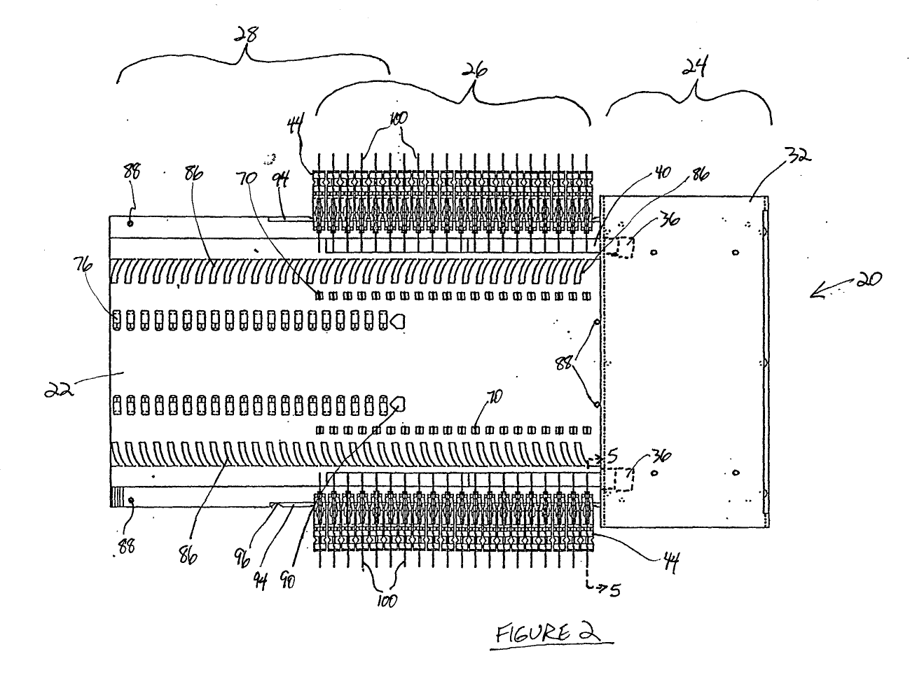

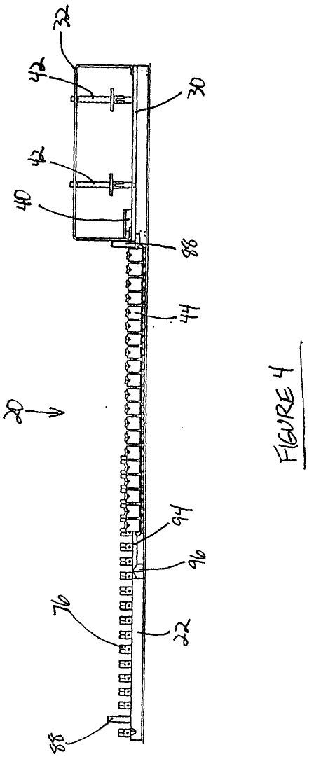

The module support region 24 may include a strain relief for the optical fibers to reduce potential damage to the module and fibers. In one illustrative embodiment, the support plate 30 may include a pair of guides 36 (shown in phantom in FIG. 2) that are adapted to lead optical fiber from the module into lateral fiber trunks 38 that extend along opposing sides of the fiber processing region. The cover 32 is provided with a pad 40 (FIG. 4) at each aperture that is configured to exert a desirable pressure against the fibers at each lead-in guide 36 to restrain the fibers between the cover 32 and the support plate 30 so that manipulation of the optical fibers on the work pallet does not create unnecessary slack in the optical fiber or allow excess optical fiber to be removed from the module support region 24 through the cover apertures 34. In one embodiment, the strain relief pads 40 may be formed from a compressible foam material. It is to be appreciated that any suitable strain relief may be implemented with the pallet.

It may be desirable to reconfigure the module support region 24 to accommodate modules of any size and shape. In one illustrative embodiment, the support plate 30 may be replaced with other support plates having any desirable configuration suitable for supporting modules of any size and shape. Similarly, the cover 32 may be replaced with other covers configured to constrain various sized modules. It is also contemplated that the module support region may support a module thereon without the use of a cover.

Although an optical circuit module may simply be placed on the module support region of the pallet, it may be desirable to positively secure the module to the pallet with or without the use of a cover. In one illustrative embodiment, one or more fasteners 42 (FIG. 4) may be provided in the module support region to secure a module to the support plate 30. The fasteners 42 may be arranged on the support plate as desired to accommodate and secure any module configuration.

As indicated above, the pallet 20 may be configured to organize the optical fibers extending from the optical circuit module and position the fibers for one or more manufacturing processes. The optical fibers may be manually or automatically loaded onto the fiber processing region 26 of the pallet. In one illustrative embodiment, the fiber processing region 26 includes a plurality of fiber process retainers 44 that are configured to locate, organize and secure optical fibers in predetermined locations on the work pallet 10. As illustrated, the process retainers 44 are arranged in one or more corresponding pairs of retainers along opposite sides of the pallet with each pair of retainers being aligned along a plane P (FIG. 2) that extends across the width of the pallet. In this manner, the process retainers 44 are configured to align pairs of corresponding fibers 100 along the plane for subsequent fiber processing and interconnection to form an optical circuit.

As shown, the process retainers 44 are configured to extend outwardly from the opposite sides of the pallet to present the individual fibers 100 to one or more fiber processing tools or stations. The process retainers 44 may be movably supported by the pallet between an extended position for fiber processing and a non-extended position in which the fiber is partially or completely retracted from the extended position. Such a configuration may allow a reduced pitch between adjacent fibers resulting in a pallet that may accommodate a greater number of fibers within the fiber processing region.

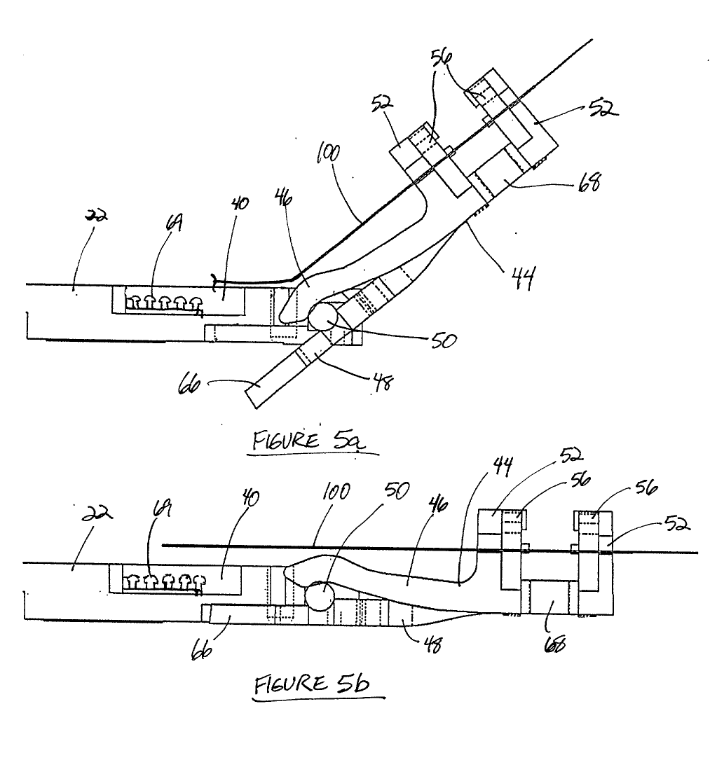

In one illustrative embodiment shown in FIGS. 5a-5b, the process retainers 44 are rotatably supported by the pallet so that opposing retainers may be raised and lowered relative to the pallet toward and away from each other to move the retainers to the non-extended (FIG. 5a) and extended (FIG. 5b) positions. When positioned relative to a processing tool, the pallet is configured so that each retainer 44 is independently rotated to its lowered/extended position for fiber processing of the fiber secured by the extended retainer. In this regard, the pallet may be configured to interact with the fiber processing tool so that a single pair of opposing retainers is extended for processing by the tool while the remaining pairs of retainers remain in the non-extended/raised position until they become positioned for fiber processing by the tool. It is to be appreciated, however that the process retainers 44 may be configured to move in a manner other than rotation. For example, the process retainers 44 could be configured to move in horizontal and/or vertical directions relative to the pallet.

The pallet 20 may be configured with any number of process retainers 44 for accommodating optical modules having varying numbers of optical fibers. In one embodiment, the fiber processing region 26 includes twenty (20) pairs of process retainers 44 to accommodate twenty (20) pairs of optical fibers for fiber processing. The pallet is configured with a 0.5 inch pitch between adjacent retainers. It should be appreciated, however, that the pallet is not limited to any particular number of process retainers 44 and the pallet may include a fewer or greater number of pairs of process retainers. It is also to be understood that the pallet may implement any suitable pitch between the retainers.

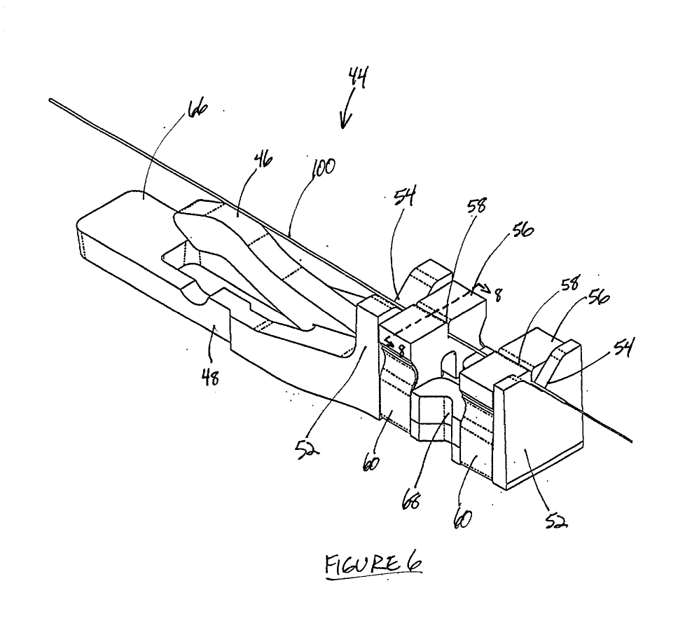

In one illustrative embodiment shown in FIGS. 5-7, each process retainer 44 includes an upper arm extension 46 and a lower arm extension 48 that are configured to receive a mounting axle 50, such as a pin, therebetween for rotatably mounting the retainer to the pallet. The arms 46, 48 may be configured to form a snap-type connection that allows the retainer to be readily removed and replaced, if necessary. The retainer 44 also includes a pair of fiber cradles 52 that are configured to guide the optical fiber 100 to a predetermined location and orientation with respect to the process retainer 44. As illustrated, each cradle 52 may include a V-shaped notch 54 along its upper edge that helps funnel the fiber into position on the retainer.

It may be desirable to configure the retainer so that it securely grips and maintains the fiber in a desired position. In one illustrative embodiment, each retainer 44 includes a pair of fiber clamps 56 located between and in close proximity to the cradles. Each clamp 56 includes a retention slot 58 defined by a pair of opposed clamping surfaces that may be moved between open and closed positions. In the closed position, the clamps 56 are configured exert a clamping force on the fiber in the retainer. In the open position, the clamps release the fiber from the retainer.

In the illustrative embodiment, each clamp 56 is secured to the retainer with a suitable fastener, such as a spring clip 60 that grips and retains both sides of the clamp. The spring clip 60 is also configured to bias the clamp to the closed position to secure the fiber in the retainer. It should be appreciated that the spring clip 60 is but one of many arrangements that could be employed to urge the clamps to engage the optical fiber 100 and secure it in the retainer 44. For example, a compression spring or elastomeric member may be employed to impose a similar bias to securely hold the optical fiber 100 in place. In one such embodiment, each clamp may be molded from a pliable material, such as a plastic material, so as to create a preload when mounted to the retainer that clamps the fiber in the closed position.

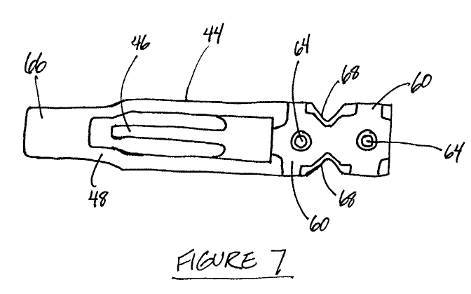

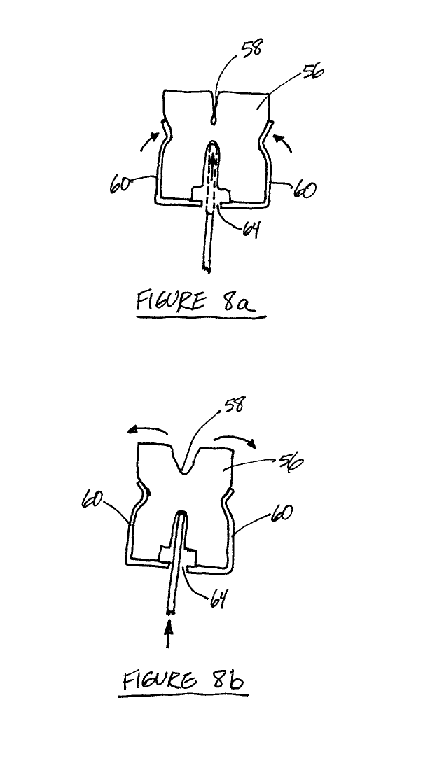

The retainer 44 may be configured for automatic actuation between the open and closed positions. In one illustrative embodiment shown in FIGS. 8a-8b, the retainer 44 may be actuated to the open position against the bias of the spring clips 60 using an actuator 62, such as an actuation pin, that may be extended through apertures 64 (FIG. 7) in the bottom of the retainer. As illustrated, the pin 62 may be extended upwardly through the retainer to engage the fiber clamp 56 (FIG. 8a) in a region below the retention slot 58 such that further extension of the pin 62 (FIG. 8b) exerts an upward force on the clamp that drives the clamp open against the bias force of the spring clip. Rotation of the retainer in response to the upward force of the actuator may be prevented, or at least limited, by restraining the end portion 66 of lower arm extension 48 against rotation about the axle 50.

While the process retainer 44 may maintain the fiber in a predetermined position relative to the processing tool or station, it may be desirable to configure the retainer so it may be precisely positioned relative to the tool. In one illustrative embodiment, the retainer 44 includes a pair of lateral receptacles 68 that are configured to cooperate with a clamp or other positioning device of the processing tool to precisely locate and maintain the retainer in its desired position relative to the tool. As shown, the receptacles 68 may have a generally V-shaped configuration extending inwardly from the lateral sides of the retainer. It is to be appreciated that the retainer may employ, if even desired, one or more alignment features of any suitable configuration for interacting with corresponding mating features of the processing tool.

The retainer 44 may be formed of a pliable plastic material, although any suitable material may be used. The fiber clamps may be formed from an elastomeric material, such as a rubber or plastic, although other materials suitable for gripping and retaining optical fiber may be employed.

As indicated above, the fiber processing region 26 may include a pair of lateral trunks 40 that are configured to organize and route the individual lengths of optical fiber along the opposite sides of the fiber processing region as the fibers extend away from the module support region 24. The pallet 20 may be configured so that each fiber exits its respective trunk 40 proximate to where the fiber extends across the width of the pallet to be secured by a process retainer 44 on the opposite side of the pallet. To facilitate the organization and handling of the fiber on the pallet, it may be desirable to anchor or otherwise secure a segment of each fiber along a portion of the trunk where the fiber exits and extends across the pallet.

In one illustrative embodiment, each trunk 40 includes a plurality of anchors that are configured to removably secure at least a segment of each fiber within the trunk. The anchors may be located adjacent the process retainers 44 to anchor a fiber as it exits the trunk to extend across the pallet to be secured by a corresponding retainer. In one illustrative embodiment shown in FIGS. 5a-5b, the anchors 69 include upstanding locking posts having enlarged heads configured to capture a fiber. In one embodiment, the anchors are formed from a DUAL LOCK recloseable fastener, available from 3M Products, that is placed along the length of each trunk. Of course, it is to be understood that any suitable anchoring arrangement may be implemented with the pallet. For example, the anchoring function may be implemented using a double-sided tape.

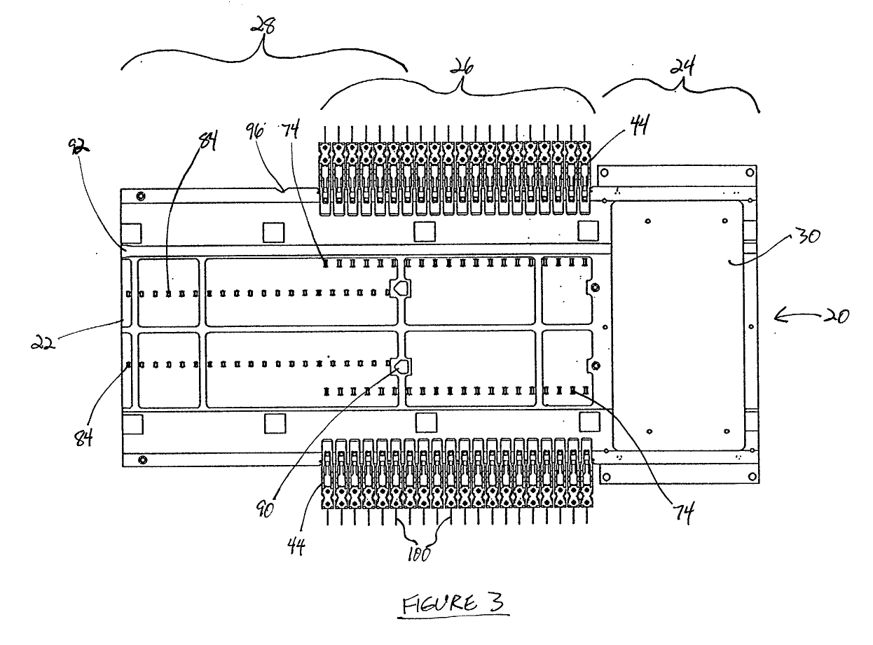

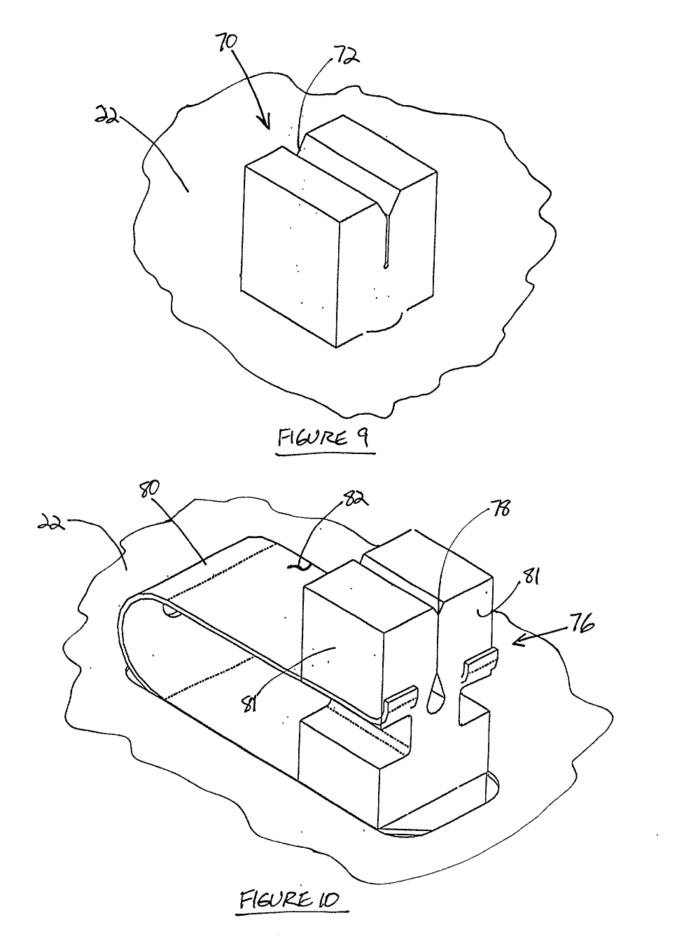

To further control fiber slack, it may be desirable to secure a segment of the fiber in the vicinity of the process retainers 44 to limit the amount of fiber that may move relative to the pallet when the process retainers are rotated between the raised and lowered positions. In one illustrative embodiment, the fiber processing region 26 includes a plurality of pairs of fiber retainers 70 that are fixed to the base 22 between each of the corresponding pairs of process retainers 44 and spaced inward from the opposite sides of the pallet. In one illustrative embodiment shown in FIG. 9, the fixed fiber retainers 70 may include a retention slot 72 that is configured to grip a segment of the fiber. The fixed retainers 70 may be connected to the base by inserting a lower portion (not shown) of the retainer into apertures 74 (FIG. 3) provided in the base 22. Although shown as passive retainers, it is contemplated that the fixed retainers may be active retainers that may be open and closed either manually or automatically. The fixed fiber retainers 70 may be formed from a pliable material, such as a rubber material, although the retainers may be formed from any suitable material, such as a plastic material, sufficiently pliable to removably retain an optical fiber.

The pallet 20 may be configured with any number of fixed retainers 70 for accommodating optical modules having varying numbers of optical fibers. In one embodiment, the fiber processing region 26 includes twenty (20) pairs of fixed retainers 70, which correspond to the twenty (20) pairs of process retainers 44, to accommodate twenty (20) pairs of finished optical fibers. The pallet may also be configured with a 0.5 inch pitch between adjacent fixed retainers 70 in a manner similar to the process retainers. It should be appreciated, however, that the pallet is not limited to any particular number of fixed retainers, although it may be desirable for the number of fixed retainers to be consistent with the number of process retainers. It is also to be understood that the pallet may implement any suitable pitch between the fixed retainers, although again it may be desirable that the pitch between the fixed retainers be equal to the pitch between the process retainers to facilitate the manufacturing process.

As indicated above, the work pallet 20 may include a fiber storage area 28 for maintaining the processed pairs of optical fiber on the pallet. As illustrated, the fiber storage region 28 may be located at the end of the pallet opposite the module support region 24 with the fiber processing region 26 located between the storage and support regions. This arrangement may be particularly advantageous when employing the pallet in a fusion splicing application in which the corresponding pairs of fiber are fused together to form a continuous fiber loop which can be subsequently extended along the length of the pallet to the fiber storage region to efficiently manage the slack associated with the spliced fiber.

In one illustrative embodiment, the fiber storage region 28 includes a plurality of storage retainers 76 arranged in lateral pairs along the length of the storage region. The pairs of storage retainers 76 are spaced so as to secure spliced fiber on opposite sides of the splice and a protective coating that may be formed along the splice. As illustrated, the pairs of storage retainers 76 may be spaced inwardly from the sides of the pallet toward the centerline of the base so that the retainers are separated by a distance that is less than the distance separating the process retainers 44. The closer spacing for the storage retainers 76 may help maintain the spliced portion of the fiber above the pallet surface by reducing the length of fiber that may potentially sag between the retainers.

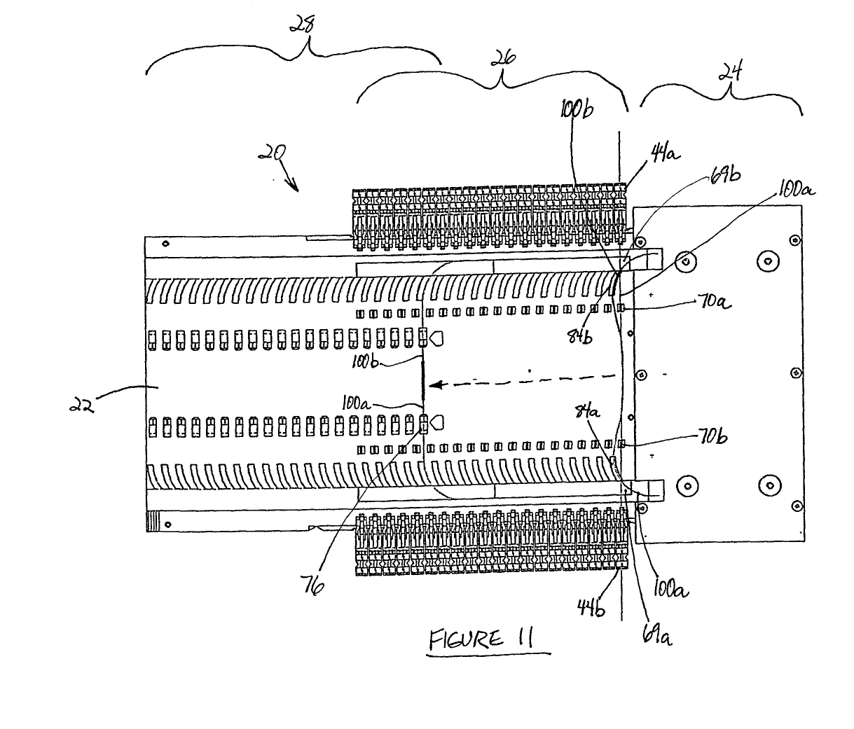

In one illustrative embodiment shown in FIG. 10, each storage retainer 76 may include a retention slot 78 formed by opposing clamp surfaces that are configured to secure a segment of the optical fiber. The storage retainer 76 may be operated between an open position to receive/release the fiber and a closed position to secure the fiber to the pallet. In the illustrative embodiment, the storage retainer 76 is urged to the closed position with a biasing element, such as a spring clip 80, that exerts an upwardly directed force against the underside of movable portions 81 of the retainer which drives the clamp surfaces toward each other to grip the fiber. The storage retainer 76 may be opened, either manually or automatically, by exerting a downward force on the upper surface 82 of the spring clip 80 to release the biasing force from the retainer so that the clamp surfaces may readily separate from each other to a preloaded open position. Similar to the fixed retainers 70 of the fiber processing region 26, the storage retainers 76 may be connected to the base by inserting a lower portion (not shown) of the retainer into apertures 84 (FIG. 3) provided in the base 22.

The pallet 20 may be configured with any number of storage retainers 76 for accommodating optical modules having varying numbers of optical fibers. In one embodiment, the fiber storage region 28 includes twenty (20) pairs of storage retainers 76, which correspond to the twenty (20) pairs of process retainers 44 in the fiber processing region 26, to accommodate twenty (20) pairs of finished optical fibers. The pallet may also be configured with a 0.5 inch pitch between adjacent storage retainers 76 in a manner similar to the process retainers. It should be appreciated, however, that the pallet is not limited to any particular number of storage retainers, although it may be desirable for the number of storage retainers to be consistent with the number of process retainers. It is also to be understood that the pallet may implement any suitable pitch between the storage retainers, although again it may be desirable that the pitch between the storage retainers be equal to the pitch between the process retainers to facilitate the manufacturing process.

It may be desirable to control the amount of fiber curvature on the pallet to prevent the fiber from violating its minimum bend radius. In one illustrative embodiment shown in FIGS. 1-2, the base 22 includes a plurality of guide ribs or rails 86 arranged in pairs along the fiber processing region 26 and the fiber storage region 28. The guide ribs 86 are configured with a curved shape to assist in guiding each optical fiber 100 to positions on the work pallet 20 without violating the minimum bend radius. In one embodiment, the guide ribs 86 are configured to prevent the optical fiber from violating a minimum bend radius of approximately 35 mm. It is to be appreciated, however, that the guide ribs may be configured for any desirable bend radius.

The pallet 20 may be provided with a stacking feature to facilitate manufacturing processes and/or storage by allowing a plurality of pallets to be stacked on top of one another. In one illustrative embodiment, the pallet includes a plurality of stacking pins 88 which cooperate with other pallets to allow the stacking of multiple work pallets. The stacking pins 88 may be configured to allow stacking of empty pallets, loaded pallets or either empty or loaded pallets.

The pallet 20 may also be provided with one or more features to facilitate its use in an automated manufacturing system. In one illustrative embodiment, the base 22 includes conveyer apertures 90 that may mate with corresponding features on a conveyer belt or other work pallet transportation system to move the pallet onto and/or along the conveyor. The pallet may also include a longitudinal channel 92 (FIG. 3) configured to align and maintain the pallet on the conveyor. As illustrated, the channel may be offset relative to the centerline of the pallet to provide a keying feature to ensure proper orientation of the pallet on the conveyor. Of course, any suitable features may be employed for pallet loading and/or transportation through a manufacturing system.

The pallet 20 may also include one or more features that facilitate accurate placement and retention of the pallet at one or more process tools or stations. In one illustrative embodiment shown in FIGS. 1-4, the pallet 20 includes chamfers 94 and a groove 96 located along the perimeter of the base 22 for registering the pallet relative to a tool. The chamfers 94 and groove 96 facilitate with the alignment of the pallet in a plurality of coordinate axes. For example, the chamfers 94 may align the pallet in the vertical direction while the groove 96 may align the pallet 10 in the horizontal directions.

The pallet may be configured to be employed with optical fiber having any of a range of diameters. In one embodiment, the pallet is configured to organize and support optical fibers having diameters ranging from approximately 180 microns to approximately 900 microns. In this regard, each of the various retainers is configured to accommodate such a range of fiber diameters. It is to be appreciated, however, that the pallet, including the retainers, may be configured to accommodate any size fiber.

The pallet may be formed from material capable of withstanding exposure to fabrication processes associated with fiber preparation, splicing and recoating of optical fiber. In one embodiment, the base 22 is formed from aluminum. Since it may also be desirable to employ a conductive material to avoid static discharge to optical components placed on the pallet, the aluminum base is coated with a conductive coating, such as a conductive irudite coating. Of course, any suitable material may be employed, such as steel or plastic materials, that may or may not be conductive depending on the particular application for the pallet.

The work pallet may be particularly suited for use with an automated fusion splice system in which pairs of optical fiber may be manipulated relative to the pallet. One example of a fusion splice system that may benefit from the pallet of the present invention is described in co-pending U.S. patent application entitled “Optical Fiber Processing System and Method”, filed on even date herewith (bearing attorney docket no. K0480/7008), and incorporated herein by reference (hereafter the “Fiber Processing Application”). However, it should be appreciated that the embodiment of the present invention directed to a work pallet for optical fiber is not limited to use with any particular fiber processing system.

In one or more processes associated with optical fiber, such as fusion splicing, recoating and the like, a certain amount of fiber slack may be needed to allow manipulation of the fiber relative to the pallet to carry out the processes. Thus, it may be desirable to configure the pallet to manage fiber slack in an organized manner to avoid problems that may arise from excess lengths of fiber being supported by the pallet.

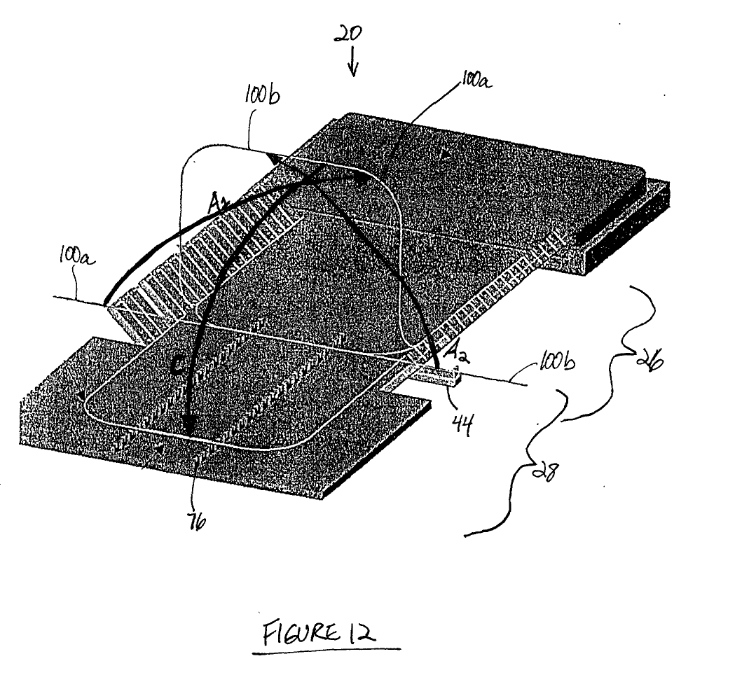

In one illustrative embodiment shown in FIG. 11, a cross-lacing arrangement may be employed with the pallet for arranging the fibers 100 to extend in opposite directions across the fiber processing region 26 of the pallet. Thus, for a pair of corresponding fibers that are to be retained by a corresponding pair of retainers, one of the fibers 100a is routed from a first side of the pallet across the fiber processing region 26 to a second side of the pallet where it is secured by a process retainer 44a along the second side of the pallet. Similarly, the other fiber 100b is routed from the second side of the pallet across the fiber processing region 26 to the first side of the pallet where it is secured by a corresponding process retainer 44b on the first side of the pallet. As illustrated, the fibers may be arranged to extend across the pallet in general alignment with the pair of retainers. Employing the cross-lacing arrangement allows the end portions of the fibers to remain oriented in the same direction for fiber preparation and fusion splicing to avoid having to rotate or otherwise twist the fibers for the various processes.

When cross-lacing the fibers in this manner, a portion of each fiber is anchored to the base 22 using an anchor 69a, 69b provided along the respective lateral trunks 40. This anchoring point allows the optical fiber to be extended across the work pallet while pivoting about the anchor. As previously discussed, the trunk 40 helps control slack in the optical fiber 100 while the fiber is positioned on the work pallet. Each of the fibers is then extended around and against a corresponding optical fiber guide rail 86a, 86b adjacent the trunk to further control the position of the optical fiber and assist in preventing the fibers from violating a minimum bend radius. To further control fiber position and slack, a portion of each fiber is secured to the base 22 using a fixed retainer 70a, 70b.

In this embodiment, a pair of optical fibers are laid out and positioned on a work pallet in a cross laced configuration, which keeps the optical fiber pairs organized and secured on the work pallet without excess slack in the optical fiber that could make the fiber unmanageable, particularly in an automated fiber process system. When loading the pallet with a multitude of pairs of optical fibers provided with an optical circuit module, each pair of fiber may be laid out and secured on the pallet using this arrangement. Although the cross-lacing arrangement may provide one or more benefits for processing optical fiber, it is to be appreciated that the pallet may be configured to implement any desirable lacing arrangement.

As indicated above, the work pallet may be particularly suited for use with an automated fusion splice system, such as a system described in the Fiber Processing Application, in which pairs of optical fiber may be manipulated relative to the pallet for fusion splicing and recoating, if desired. As schematically illustrated in FIG. 12, the processed fibers 100a, 100b may be lifted from the pallet in the direction of arrows A₁, A₂ to a raised position B where the opposed fiber ends are spliced to form a closed fiber loop as part of an optical circuit. The fused fiber loop is then lowered to the pallet in the direction of arrow C to a position, indicated by arrow D, in the fiber storage region 28. In this manner, the spliced fiber section, identified by arrow E, is secured between a pair of storage retainers 76 in the fiber storage region 28.

As shown in FIG. 11, the pair of optical fibers 100a, 100b are positioned in the fiber processing region 26 in the pair of process retainers 44 closest to the module support region 24. When moved to the fiber storage region 28 as shown in FIG. 11, the pair of optical fibers 100a, 100b, which have been splice together, are positioned in a corresponding pair of storage retainers located closest to the module support region 24. In a similar manner, each pair of fibers positioned in one of the pairs of process retainers may be moved to its corresponding pair of storage retainers at the completion of a splicing process.

Having described several illustrative embodiments of the invention in detail, various modifications and improvements will readily occur to those skilled in the art. Such modifications and improvements are intended to be within the scope of the invention. Accordingly, the foregoing description is by way of example only and is not intended as limiting. The invention is limited only as defined by the following claims and the equivalents thereto.

What is claimed is:

1. A work pallet for processing optical fiber, the work pallet comprising:
a base constructed and arranged to support a plurality of optical fibers thereon; and
a plurality of retainers movably supported by the base, the plurality of retainers being arranged in a plurality of opposing pairs of retainers disposed along opposite sides of the base, each of the retainers being constructed and arranged to secure an end portion of an optical fiber to the base at a predetermined location, each of the retainers being movable between a first position to maintain the end portion of the optical fiber in a first position relative to the base and a second position to maintain the end portion of the optical fiber in a second position relative to the base that is different from the first position.

2. The work pallet according to claim 1, wherein each of the plurality of retainers is rotatable relative to the base.

3. The work pallet according to claim 2, wherein each of the plurality of retainers is rotatable independent of the others of the plurality of retainers.

4. The work pallet according to claim 1, wherein each of the plurality of retainers includes at least one mating feature that is constructed and arranged to mate with a positioning device to locate and maintain the retainer in a predetermined location relative to a processing tool.

5. The work pallet according to claim 4, wherein the at least one mating feature includes a pair of lateral receptacles adapted to receive the positioning device

6. The work pallet according to claim 1, wherein each of the plurality of retainers includes at least one clamp constructed and arranged to secure the end portion of the optical fiber in the retainer.

7. The work pallet according to claim 6, wherein the clamp is movable between open and closed positions to respectively release and secure the end portion of the optical fiber.

8. The work pallet according to claim 1, wherein each of the plurality of retainers includes at least one cradle that is constructed and arranged to position the end portion of the optical fiber in a predetermined location relative to the base.

9. The work pallet according to claim 1, wherein each of the plurality of retainers is movable between an extended position and a non-extended position.

10. The work pallet according to claim 9, wherein each of the plurality of opposing pairs of retainers move away from each other when moved toward the extended position and move toward each other when moved toward the non-extended position

11. The work pallet according to claim 1, wherein each of the plurality of retainers extends outwardly from the base.

12. The work pallet according to claim 1, wherein the base includes at least a module support region and a fiber processing region, the optical module region being constructed and arranged to support an optical component on the base with the plurality of optical fibers extending therefrom, the plurality of retainers being disposed in the fiber processing region.

13. The work pallet according to claim 1, further comprising a plurality of fixed retainers supported by the base, the plurality of fixed retainers being arranged in opposing pairs of fixed retainers, each of the fixed retainers being constructed and arranged to secure an end portion of an optical fiber to the base at a predetermined location that differs from the predetermined locations of the plurality of movable retainers.

14. The work pallet according to claim 13, wherein each of the plurality of fixed retainers is movable between open and closed positions to respectively release and secure the end portion of the optical fiber.

15. A work pallet for processing optical fiber, the work pallet comprising:
a base including an optical module region, a fiber processing region and a fiber storage region;
the optical module region being constructed and arranged to support an optical component on the base with at least one pair of optical fibers extending from the optical component;
the fiber processing region including at least one pair of first retainers supported by the base, the at least one pair of first retainers being constructed and arranged to secure end portions of the at least one pair of optical fibers in a first orientation; and
the fiber storage region including at least one pair of second retainers supported by the base, the at least one pair of second retainers being constructed and arranged to secure the end portions of the at least one pair of optical fibers in a second orientation that is different from the first orientation.

16. The work pallet according to claim 15, wherein the at least one pair of first retainers are movably supported by the base.

17. The work pallet according to claim 16, wherein the at least one pair of first retainers are rotatable relative to the base.

18. The work pallet according to claim 15, wherein the at least one pair of second retainers are fixed to the base.

19. The work pallet according to claim 15, wherein the at least one pair of first retainers are aligned along a first plane, and the at least one pair of second retainers are aligned along a second plane that is spaced from and parallel to the first plane.

20. The work pallet according to claim 19, wherein the at least one pair of first retainers are spaced apart a first distance along the first plane and the at least one pair of second retainers are spaced apart a second distance along the second plane, the second distance being less than the first distance.

21. The work pallet according to claim 15, wherein the at least one pair of first retainers are operable between open and closed positions to respectively release and secure the end portions of the at least one pair of optical fibers.

22. The work pallet according to claim 21, wherein the at least one pair of second retainers are operable between open and closed positions to respectively release and secure the end portions of the at least one pair of optical fibers.

23. The work pallet according to claim 15, further comprising at least one pair of anchors located in the fiber processing region to secure portions of the at least one pair of optical fibers at a location spaced from the end portions thereof.

24. The work pallet according to claim 15, further comprising at least one pair of fiber guides supported by the base that are constructed and arranged to permit bending of the at least one pair of optical fibers without violating a minimum bend radius of the optical fibers.

25. The work pallet according to claim 15, wherein the at least one pair of first retainers includes a plurality of pairs of movable retainers.

26. The work pallet according to claim 25, where in the at least one pair of second retainers includes a plurality of pairs of fixed retainers.

27. The work pallet according to claim 15, wherein the module support region includes a replaceable support plate.

28. The work pallet according to claim 15, wherein the module support region includes at least one fastener that is constructed and arranged to secure the optical component thereon.

29. A work pallet for processing optical fiber, the work pallet comprising:
a base constructed and arranged to support at least one pair of optical fibers thereon;
at least one pair of first retainers movably supported by the base, the at least one pair of first retainers being constructed and arranged to secure the at least one pair of optical fibers in a first predetermined location relative to the base; and
at least one pair of second retainers fixedly supported by the base, the at least one pair of second retainers being constructed and arranged to secure the at least one pair of optical fibers in a second predetermined location relative to the base that is different from the first predetermined location.

30. The work pallet according to claim 29, wherein each of the pair of first retainers is rotatable relative to the base.

31. The work pallet according to claim 29, wherein each of the pair of first retainers is movable between an extended position and a non-extended position.

32. The work pallet according to claim 29, wherein each of the pair of first retainers is operable between open and closed positions to respectively release and secure the optical fiber.

33. The work pallet according to claim 29, wherein each of the pair of first retainers extends outwardly from the base.

34. The work pallet according to claim 29, wherein the at least one pair of first retainers are aligned along a first plane, and the at least one pair of second retainers are aligned along a second plane that is spaced from and parallel to the first plane.

35. The work pallet according to claim 34, wherein the at least one pair of first retainers are spaced apart a first distance along the first plane and the at least one pair of second retainers are spaced apart a second distance along the second plane, the second distance being less than the first distance.

36. The work pallet according to claim 29, wherein each of the at least one pair of second retainers is operable between open and closed positions to respectively release and secure the end portions of the at least one pair of optical fibers.

37. The work pallet according to claim 29, further comprising at least one pair of fiber guides supported by the base that are constructed and arranged to permit bending of the at least one pair of optical fibers without violating a minimum bend radius of the optical fibers.

38. The work pallet according to claim 29, wherein the at least one pair of first retainers includes a plurality of pairs of first retainers.

39. The work pallet according to claim 38, wherein the at least one pair of second retainers includes a plurality of pairs of second retainers.

40. The work pallet according to claim 38, wherein the plurality of pairs of first retainers are movable independent of each other.

41. A work pallet for processing optical fiber, the work pallet comprising:
a base constructed and arranged to support at least one pair of optical fibers thereon;
at least one pair of first retainers supported by the base and disposed opposite each other, the at least one pair of first retainers being aligned along a first plane and spaced apart by a first distance, the at least one pair of first retainers being constructed and arranged to secure end portions of the at least one pair of optical fibers along the first plane; and
at least one pair of second retainers supported by the base and disposed opposite each other, the at least one pair of second retainers being aligned with each other along a second plane and spaced apart by a second distance that is less than the first distance, the second plane being parallel to and spaced from the first plane, the at least one pair of second retainers being constructed and arranged to secure the end portions of the at least one pair of optical fibers along the second plane.

42. The work pallet according to claim 41, wherein the at least one pair of first retainers are movably supported by the base.

43. The work pallet according to claim 42, wherein the at least one pair of first retainers are rotatable relative to the base.

44. The work pallet according to claim 42, wherein the at least one pair of second retainers are fixed to the base.

45. The work pallet according to claim 41, wherein the at least one pair of first retainers are movable between an extended position and a non-extended position.

46. The work pallet according to claim 45, wherein the at least one pair of first retainers move away from each other when moved toward the extended position and move toward each other when moved toward the non-extended position

47. The work pallet according to claim 41, wherein the at least one pair of first retainers extend outwardly from the base.

48. The work pallet according to claim 41, wherein the at least one pair of first retainers are operable between open and closed positions to respectively release and secure the end portions of the at least one pair of optical fibers.

49. The work pallet according to claim 48, wherein the at least one pair of second retainers are operable between open and closed positions to respectively release and secure the end portions of the at least one pair of optical fibers.

50. The work pallet according to claim 41, further comprising at least one pair of anchors disposed on the base to secure portions of the at least one pair of optical fibers at a location spaced from the end portions thereof.

51. The work pallet according to claim 41, further comprising at least one pair of fiber guides supported by the base that are constructed and arranged to permit bending of the at least one pair of optical fibers without violating a minimum bend radius of the optical fibers.

52. The work pallet according to claim 41, wherein the at least one pair of first retainers includes a plurality of pairs of movable retainers.

53. The work pallet according to claim 52, wherein the at least one pair of second retainers includes a plurality of pairs of fixed retainers.

54. The work pallet according to claim 41, wherein the base is constructed and arranged to support an optical component thereon with the at least one pair of optical fibers extending from the optical component.

55. A method of arranging optical fibers on a work pallet for processing the optical fibers, the method comprising steps of:
(a) placing first and second optical fibers on a work pallet, the work pallet including a first retainer disposed along a first side of the pallet and a second retainer disposed opposite the first retainer along a second side of the pallet, the first and second retainers being constructed and arranged to secure an end portion of an optical fiber in a predetermined location on the pallet;
(b) routing the first optical fiber across the pallet from the first side to the second side;
(c) securing the end portion of the first optical fiber to the pallet with the second retainer;
(d) routing the second optical fiber across the pallet from the second side to the first side adjacent a length portion of the first optical fiber; and
(e) securing the end portion of the second optical fiber to the pallet with the first retainer.

56. The method according to claim 55, wherein step (a) includes supporting an optical circuit module on the work pallet with the first and second optical fibers extending from the optical circuit module.

57. The method according to claim 55, wherein step (b) includes anchoring a portion of the first optical fiber at a first anchoring position on the first side of the pallet.

58. The method according to claim 57, wherein step (b) further includes pivoting the first optical fiber about the first anchoring position.

59. The method according to claim 57, wherein step (d) includes anchoring a portion of the second optical fiber at a second anchoring position on the second side of the pallet.

60. The method according to claim 59, wherein step (d) further includes pivoting the second optical fiber about the second anchoring position.

61. The method according to claim 55, wherein step (b) further includes bending the first optical fiber about a first fiber guide disposed on the first side of the pallet.

62. The method according to claim 61, wherein step (b) further includes bending the first optical fiber without violating a minimum bend radius of the optical fiber.

63. The method according to claim 62, wherein the step (d) further includes bending the second fiber about a second fiber guide disposed on the second side of the pallet.

64. The method according to claim 63, wherein the step (d) further includes bending the second optical fiber without violating a minimum bend radius of the optical fiber.

65. The method according to claim 55, wherein step (b) includes securing a portion of the first optical fiber with a third retainer provided between the first and second retainers.

66. The method according to claim 65, wherein step (d) includes securing a portion of the second optical fiber with a fourth retainer provided between the first and third retainers.

67. The method according to claim 55, wherein step (c) includes securing the end portion of the first optical fiber extending outwardly from the base.

68. The method according to claim 67, wherein the step (e) comprises securing the end portion of the second optical fiber extending outwardly from the base in a direction opposite the end portion of the first optical fiber.
